(19) United States
(12) Patent Application Publication
(10) Pub. No.: US 2021/0190120 A1
(43) Pub. Date: Jun. 24, 2021

(54) Wing-Shaped Thrust Screw

(71) Applicant: Wei-Chih Chen, Taichung City (TW)

(72) Inventor: Wei-Chih Chen, Taichung City (TW)

(21) Appl. No.: 16/742,101

(22) Filed: Jan. 14, 2020

(30) Foreign Application Priority Data
Dec. 20, 2019 (TW) 108147032

(51) Int. Cl. F16B 25/10; F16B 25/00

(52) U.S. Cl. CPC F16B 25/103; F16B 25/0084; F16B 25/0063; F16B 25/0015; F16B 25/0089

(57) ABSTRACT

A thrust screw includes a head, a first shank, a second shank, and a drilling member. The first shank and the second shank are arranged between the head and the drilling member. The second shank is provided with an external thread. The first shank is provided with a thrust member corresponding to the external thread. The thrust member includes two wing-shaped stop pieces and two flat portions. The two flat portions are formed on the two wing-shaped stop pieces respectively and correspond to the external thread. The two flat portions have an outer diameter greater than that of the external thread. The two flat portions of the thrust member stop a further screwing motion of the external thread.

### BACKGROUND OF THE INVENTION

### 1. Field of the Invention

The present invention relates to a screw and, more particularly, to a wing-shaped thrust screw (or self-tapping screw).

### 2. Description of the Related Art

A conventional anchor for masonry veneer walls was disclosed in the U.S. Pat. No. 4,764,069. The tail end of the wall anchor is provided with an internally threaded hole for locking a headless screw, so that the headless screw can be locked and fixed in the internally threaded hole of the wall anchor. The headless screw has a tail provided with a drill tip. The outer diameter of the tail end of the wall anchor is larger than that of the thread of the headless screw, thereby forming a thrust part to prevent a further screwing motion of the headless screw. The wall anchor and the headless screw are produced individually. The wall anchor and the headless screw are made the zinc alloy which is cast and then tapped to form the thread, and finally the headless screw is locked in the internal thread hole of the wall anchor. However, the wall anchor and the headless screw are not formed integrally, and have a complicated working process, thereby increasing the cost of fabrication.

A conventional fastener for logs and fastening technique therefor was disclosed in the U.S. Pat. No. 6,050,765. The fastener is provided with two enlarged portions which are mainly used for hole expansion and chip removal during cutting. The two enlarged portions do not have a thrust function and cannot prevent a further screwing motion of the external thread.

A conventional stainless steel self-tapping screw was disclosed in the Taiwanese Patent Publication No. M311788. The stainless steel screw has a top provided with an enlarged cap portion, a middle provided with a screw body, and a bottom provided with a drill blade. The screw body is provided with a thread section and two convex fin portions. When the self-tapping screw is used to lock a non-metal plate and a metal skeleton, the two convex fin portions enlarge the bore of the non-metal plate, so that a space is kept between the screw body and the non-metal plate, to provide an expansion space when heat expansion occurs. Each of the two convex fin portions is a thin plate, such that when the two convex fin portions pass through the non-metal plate and touch the metal skeleton, the two convex fin portions are broken and detached from the screw body, and will not affect the metal skeleton. Thus, the screw body and the metal skeleton are connected steadily. However, the two convex fin portions do not have a thrust function, and cannot stop a further screwing motion of the thread section.

A conventional self-tapping screw 40 in accordance with the prior art shown in FIGS. 1-3 comprises a head 41, a first shank 43, a second shank 44, and a drilling member 42. The head 41 is provided with a restriction portion 411 which is provided with a rotation portion 412 which is provided with a through hole 413. The drilling member 42 includes a pointed portion 421. Thus, the rotation portion 412 is driven and rotated by a driving tool to rotate the self-tapping screw 40. The second shank 44 is provided with an external thread 441. A thrust member 45 is formed between the first shank 43 and the external thread 441. The thrust member 45 includes a stop ring 452 and a groove 451. A washer 50 is mounted on the bottom of the stop ring 452, and a resilient washer 51 is mounted on the bottom of the washer 50. A perforation 52 is formed in the washer 50 and the resilient washer 51. In fabrication, the thrust member 45 is formed by extrusion, such that a material for forming the groove 451 is squeezed downward to form the stop ring 452. Thus, the stop ring 452 has a diameter slightly greater than that of the external thread 441. In operation, the rotation portion 412 is driven and rotated by the driving tool to rotate the self-tapping screw 40, such that the pointed portion 421 is drilled through a cement 1, and the external thread 441 is screwed into the cement 1. When the stop ring 452 touches the washer 50, the self-tapping screw 40 stops rotating. However, when the self-tapping screw 40 is deflected from the washer 50, the stop ring 452 easily passes through the perforation 52, such that the stop ring 452 is deformed or broken by the washer 50, and the thrust member 45 cannot stop a further movement of the external thread 441.

### BRIEF SUMMARY OF THE INVENTION

The primary objective of the present invention is to provide a wing-shaped thrust screw that stops rotation during a preset distance.

In accordance with the present invention, there is provided a thrust screw comprising a head, a first shank, a second shank, and a drilling member. The first shank and the second shank are arranged between the head and the drilling member. The second shank is provided with an external thread. The first shank is provided with a thrust member corresponding to the external thread. The thrust member includes two wing-shaped stop pieces and two flat portions. The two flat portions are formed on the two wing-shaped stop pieces respectively and correspond to the external thread. The two flat portions have an outer diameter greater than that of the external thread. The two flat portions of the thrust member stop a further screwing motion of the external thread. The first shank is worked by a first molding process to form the thrust member with the two wing-shaped stop pieces, and the thrust member is worked by a second molding process to form the two flat portions on the two wing-shaped stop pieces respectively.

According to the primary advantage of the present invention, the thrust screw is formed integrally with the thrust member, such that the external thread is not screwed or locked too deeply due to a defective working or assembling process or due to an improper operation of the user, thereby preventing the thrust screw from being broken or worn out during rotation. Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional self-tapping screw in accordance with the prior art.

FIG. 2 is a schematic operational view showing a screwing operation of the conventional self-tapping screw.

FIG. 3 is a schematic operational view showing finish of the screwing operation of the conventional self-tapping screw.

FIG. 4 is a perspective view of a thrust screw in accordance with the first preferred embodiment of the present invention.

FIG. 5 is a front view of the thrust screw as shown in FIG. 4.

FIG. 6 is a cross-sectional view of the thrust screw taken along line E-E as shown in FIG. 5.

FIG. 7 is a schematic operational view showing a screwing operation of the thrust screw in accordance with the first preferred embodiment of the present invention.

FIG. 8 is a schematic operational view of the thrust screw as shown in FIG. 7.

FIG. 9 is a perspective view of a thrust screw in accordance with the second preferred embodiment of the present invention.

FIG. 10 is a front view of the thrust screw as shown in FIG. 9.

FIG. 11 is a cross-sectional view of the thrust screw taken along line F-F as shown in FIG. 10.

FIG. 12 is a schematic operational view showing a screwing operation of the thrust screw in accordance with the second preferred embodiment of the present invention.

FIG. 13 is a schematic operational view of the thrust screw as shown in FIG. 12.

FIG. 14 is a schematic operational view of a thrust screw in accordance with the third preferred embodiment of the present invention.

FIG. 15 is a schematic operational view of a thrust screw in accordance with the fourth preferred embodiment of the present invention.

FIG. 16 is a perspective view of a thrust screw in accordance with the fifth preferred embodiment of the present invention.

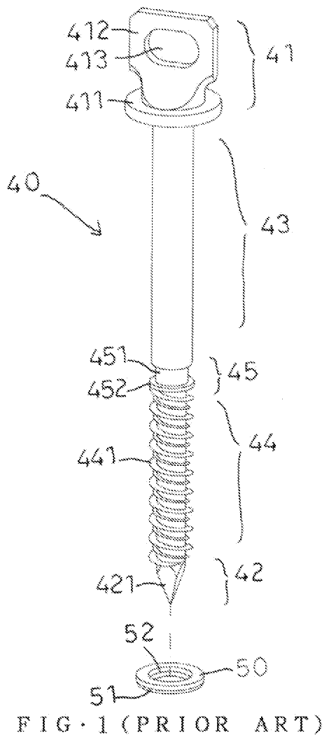

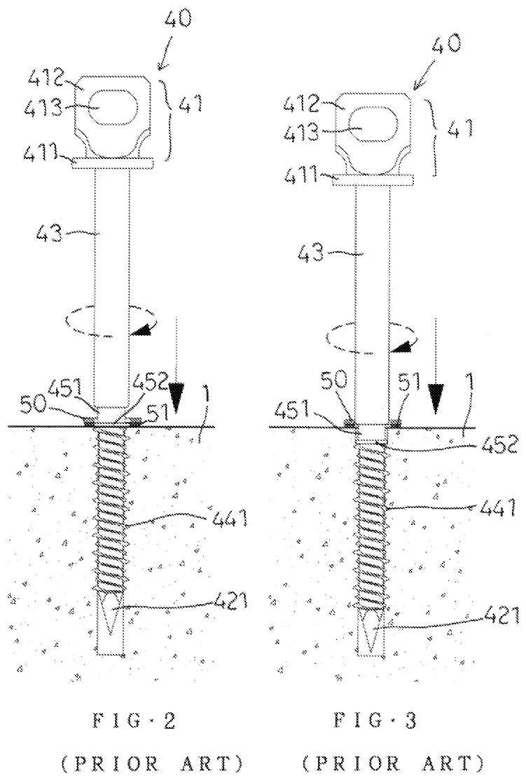

### DETAILED DESCRIPTION OF THE INVENTION

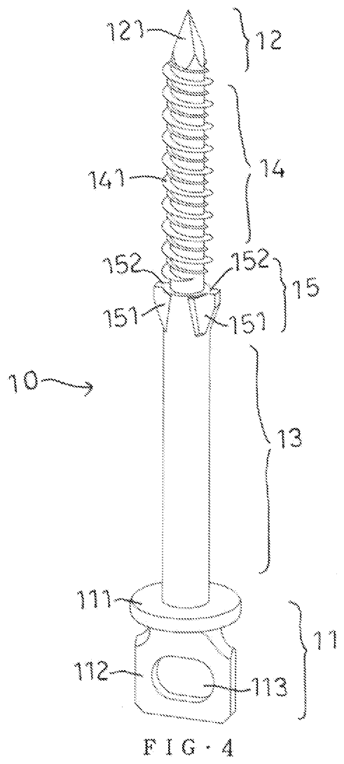

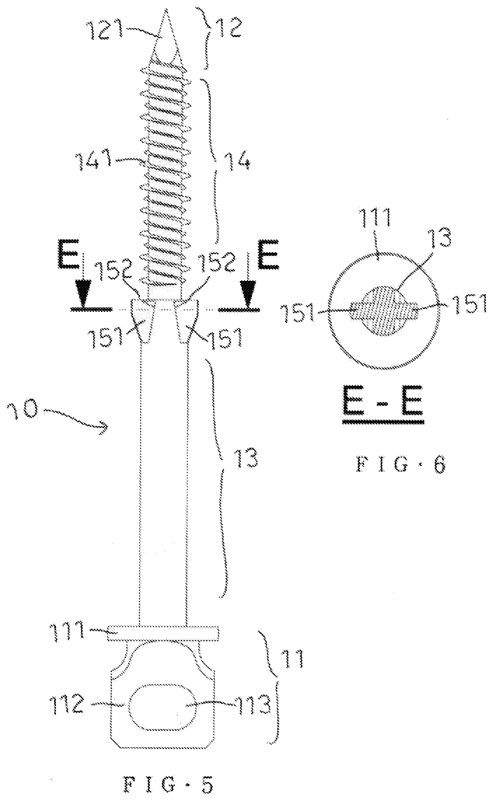

Referring to the drawings and initially to FIGS. 4-6, a thrust screw 10 in accordance with the preferred embodiment of the present invention comprises a head 11, a first shank 13, a second shank 14, and a drilling member 12.

The first shank 13 and the second shank 14 are arranged between the head 11 and the drilling member 12. The second shank 14 is provided with an external thread 141. The first shank 13 is provided with a thrust member (or stop member) 15 corresponding to the external thread 141. The thrust member 15 is connected with the external thread 141 of the second shank 14 and includes two wing-shaped (or fin-shaped) stop pieces 151 and two flat portions 152. The two wing-shaped stop pieces 151 are formed on and protrude outward from the first shank 13. The two flat portions 152 are formed on the two wing-shaped stop pieces 151 respectively and correspond to the external thread 141. The two flat portions 152 have an outer diameter (or a dimension) greater than that of the external thread 141 and greater than that of the first shank 13. Thus, the two flat portions 152 of the thrust member 15 stop a further movement of the external thread 141 and prevent a further screwing motion of the external thread 141.

In fabrication, the first shank 13 is worked by a first molding process to form the thrust member 15 with the two wing-shaped stop pieces 151, and the thrust member 15 is worked by a second molding process to form the two flat portions 152 on the two wing-shaped stop pieces 151 respectively. Preferably, the two wing-shaped stop pieces 151 are formed integrally on the first shank 13 by stamping, punching or pressing, and the two flat portions 152 are formed on the two wing-shaped stop pieces 151 respectively by turning or cutting.

In the preferred embodiment of the present invention, the drilling member 12 includes a pointed (or conic or tapered) portion 121.

In the preferred embodiment of the present invention, the head 11 is provided with a circular restriction portion 111 disposed horizontally. The restriction portion 111 is provided with a rotation portion 112 disposed vertically. Thus, the rotation portion 112 is driven and rotated by a driving tool to rotate the thrust screw 10.

In the preferred embodiment of the present invention, the rotation portion 112 is a sheet plate.

In the preferred embodiment of the present invention, the rotation portion 112 is provided with a through hole 113.

In the preferred embodiment of the present invention, the thrust member 15 has a height that is adjusted according to the thickness of a workpiece.

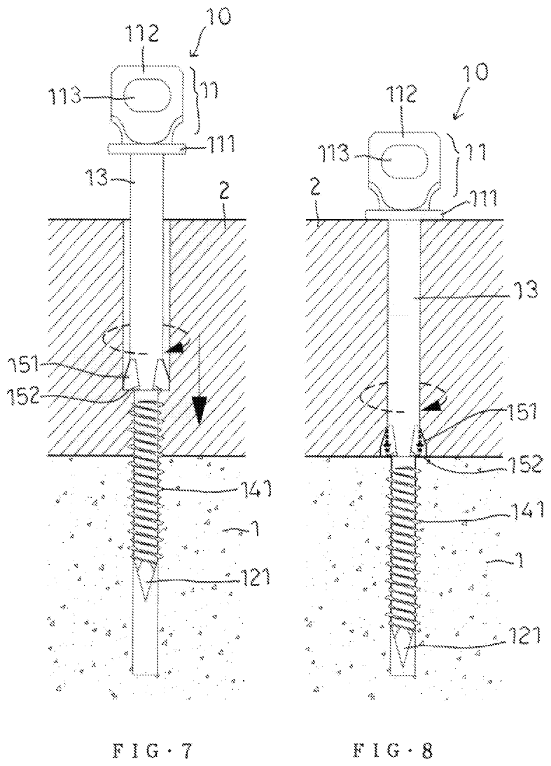

In operation, referring to FIGS. 7 and 8 with reference to FIGS. 4-6, a first article 2 is placed on a cement (or concrete) 1. When the rotation portion 112 is driven and rotated by the driving tool, the thrust screw 10 is rotated, such that the pointed portion 121 of the drilling member 12 is drilled through the first article 2 into the cement 1, and the external thread 141 is screwed through the first article 2 into the cement 1 as shown in FIG. 7. When the two flat portions 152 of the thrust member 15 touch the cement 1, and the restriction portion 111 of the head 11 touches the first article 2 as shown in FIG. 8, the thrust screw 10 stops rotating.

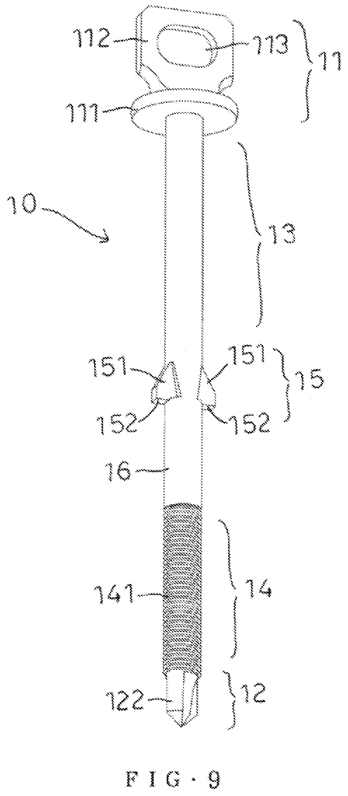

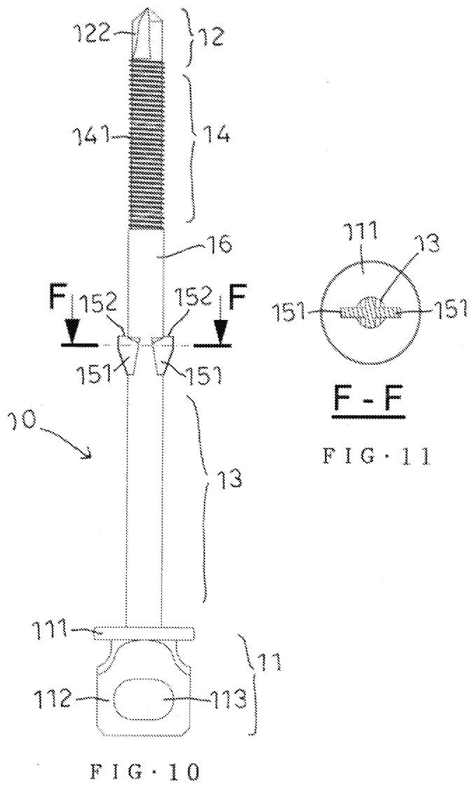

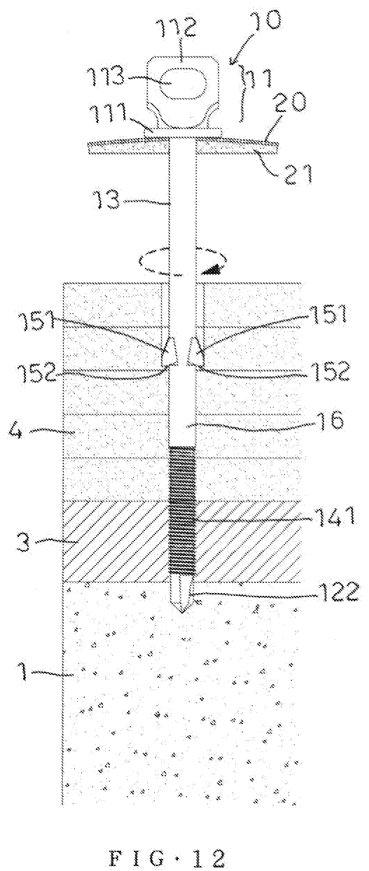

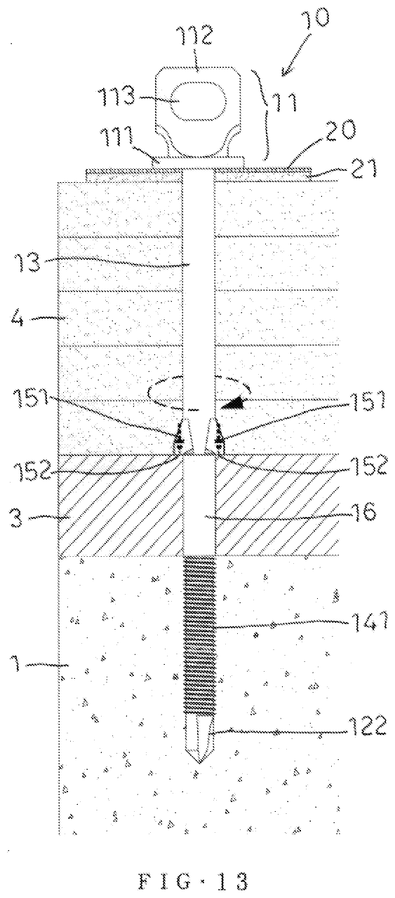

Referring to FIGS. 9-13, the drilling member 12 includes a drill tip 122. The thrust member 15 is spaced from the external thread 141, and the thrust screw 10 further comprises a third shank 16 located between the thrust member 15 and the external thread 141, a washer 20 mounted on the first shank 13 and located under the head 11, and an elastic cushion (or pad or spacer or washer) 21 mounted on the first shank 13 and located under the washer 20. The washer 20 rests on a bottom of the restriction portion 111 of the head 11. The elastic cushion 21 rests on a bottom of the washer 20.

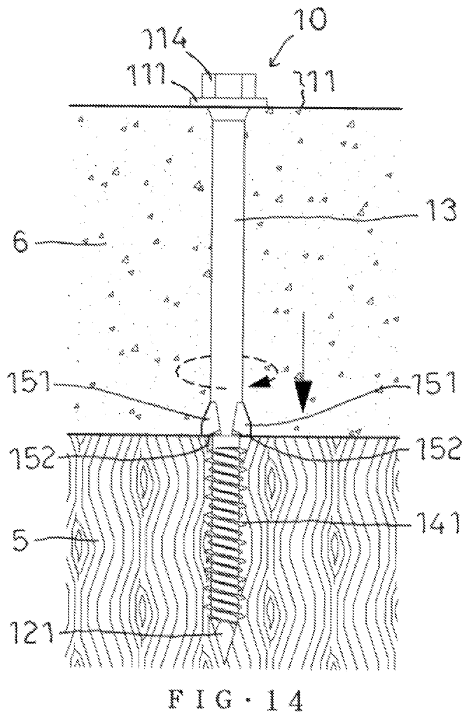

In operation, referring to FIGS. 12 and 13 with reference to FIGS. 9-11, a second article 3 is placed on the cement 1, and a plurality of third articles 4 are placed on the second article 3. When the rotation portion 112 is driven and rotated by the driving tool, the thrust screw 10 is rotated, such that the drill tip 122 of the drilling member 12 is drilled through the third articles 4, and the second article 3 into the cement 1, and the external thread 141 is screwed through the third articles 4, and the second article 3 into the cement 1 as shown in FIG. 12. When the two flat portions 152 of the thrust member 15 touch the second article 3, and the elastic cushion 21 touches the uppermost one of the third articles 4 as shown in FIG. 13, the thrust screw 10 stops rotating. In such a manner, the washer 20 and the elastic cushion 21 separate the head 11 from the third articles 4 to prevent the head 11 from pressing the third articles 4 directly. In addition, the elastic cushion 21 has a resilient feature to enhance the screwing and locking force of the external thread 141, such that the washer 20 and the elastic cushion 21 rest on the third articles 4 smoothly and evenly.

Referring to FIG. 14, the restriction portion 111 is provided with a rotation portion 114 disposed vertically. Preferably, the rotation portion 114 is a hexagonal nut. Thus, the rotation portion 114 is driven and rotated by a driving tool, such as a socket wrench, to rotate the thrust screw 10.

In operation, when the rotation portion 114 is driven and rotated by the driving tool, the thrust screw 10 is rotated, such that the pointed portion 121 of the drilling member 12 is drilled into a wood element 5, and the external thread 141 is screwed into the wood element 5. When the two flat portions 152 of the thrust member 15 touch the wood element 5, the thrust screw 10 stops rotating. Then, a cement 6 is poured to the wood element 5. The height of the cement 6 increases gradually until the cement 6 touches the restriction portion 111 of the head 11.

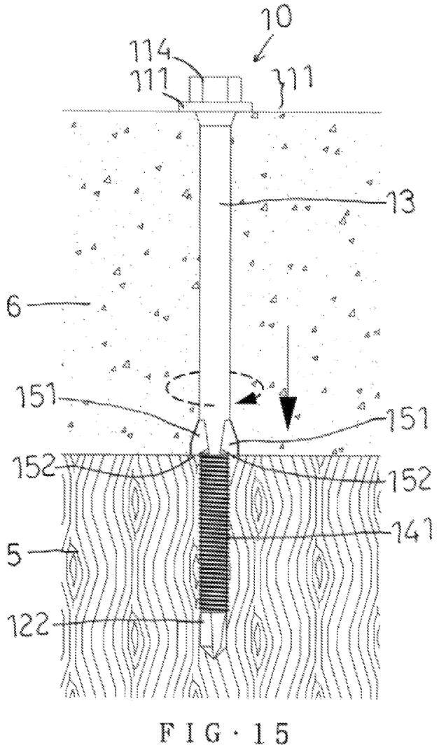

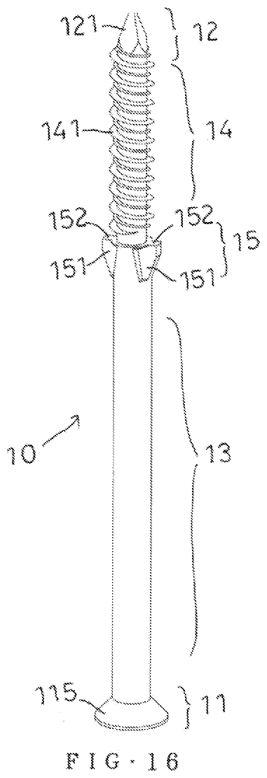

Referring to FIG. 15 with reference to FIG. 14, the pointed portion 121 is replaced by the drill tip 122.

Referring to FIG. 16, the head 11 is directly provided with a rotation portion 115. The rotation portion 115 has a tapered (or conic) shape and is provided with a driving slot. Preferably, the driving slot has a flat shape or a cross shape. Thus, the rotation portion 112 is driven and rotated by a driving tool, such as a screwdriver, to rotate the thrust screw 10.

Accordingly, the thrust screw 10 is formed integrally with the thrust member 15, such that the external thread 141 is not screwed or locked too deeply due to a defective working or assembling process or due to an improper operation of the user, thereby preventing the thrust screw 10 from being broken or worn out during rotation. In addition, the two flat portions 152 have an outer diameter greater than that of the external thread 141, to stop a further screwing motion of the external thread 141.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A thrust screw comprising:
a head, a first shank, a second shank, and a drilling member;
wherein:
the first shank and the second shank are arranged between the head and the drilling member;
the second shank is provided with an external thread;
the first shank is provided with a thrust member corresponding to the external thread;
the thrust member includes two wing-shaped stop pieces and two flat portions;
the two flat portions are formed on the two wing-shaped stop pieces respectively and correspond to the external thread;
the two flat portions have an outer diameter greater than that of the external thread;
the two flat portions of the thrust member stop a further screwing motion of the external thread;
the first shank is worked by a first molding process to form the thrust member with the two wing-shaped stop pieces, and the thrust member is worked by a second molding process to form the two flat portions on the two wing-shaped stop pieces respectively.

2. The thrust screw of claim 1, wherein the drilling member includes a pointed portion.

3. The thrust screw of claim 1, wherein the drilling member includes a drill tip.

4. The thrust screw of claim 1, further comprising:
a washer mounted on the first shank and located under the head; and
an elastic cushion mounted on the first shank and located under the washer.

5. The thrust screw of claim 1, further comprising:
a third shank located between the thrust member and the external thread.

6. The thrust screw of claim 1, wherein the head is provided with a restriction portion disposed horizontally, and the restriction portion is provided with a rotation portion disposed vertically.

7. The thrust screw of claim 6, wherein the rotation portion is a sheet plate.

8. The thrust screw of claim 6, wherein the rotation portion is a hexagonal nut.

9. The thrust screw of claim 6, wherein the rotation portion is provided with a through hole.

10. The thrust screw of claim 1, wherein the head is provided with a rotation portion, and the rotation portion has a tapered shape and is provided with a driving slot.
